(19) United States
(12) Patent Application Publication
(10) Pub. No.: US 2008/0217969 A1
(43) Pub. Date: Sep. 11, 2008

(54) Motorcycle Backrest

(76) Inventor: Clarence H. Mills, Russellville, AL (US)

Correspondence Address: LANIER FORD SHAVER & PAYNE P.C., P O BOX 2087, HUNTSVILLE, AL, 35804-2087, US

(21) Appl. No.: 12/045,284

(22) Filed: Mar. 10, 2008

Related U.S. Application Data
(60) Provisional application No. 60/893,803, filed on Mar. 8, 2007.

(51) Int. Cl. B62J 1/28

(52) U.S. Cl. 297/215.1

(57) ABSTRACT

A motorcycle backrest is claimed. The motorcycle backrest a closed-end, substantially cylindrical geometry filled with a resilient stuffing, having an elongated tongue tangentially extended therefrom, and at least one strap connected on either end of the cylinder running substantially parallel thereto. The motorcycle backrest is maintained in position on the motorcycle by threading the elongated tongue through an existing motorcycle seat strap, or through a retro-fit belt or strap secured around the motorcycle seat between the driver and passenger portion of the motorcycle seat. Next, the tongue is threaded through the strap of the motorcycle backrest. The elongated tongue is of sufficient length so that, when installed, the driver sits on the tongue thereby ensuring the backrest stays in place during the operation of the motorcycle.

### REFERENCE TO RELATED APPLICATION

This application claims priority to U.S. Provisional Patent Application Ser. No. 60/893,803 entitled “Motorcycle Backrest,” filed on Mar. 8, 2007, which is fully incorporated herein by reference.

### FIELD OF THE DISCLOSURE

The present disclosure relates generally to the field of cushioning and ergonomic support. In particular, the present disclosure relates to a device adapted to provide comfort and support while traveling on a motorcycle. More particularly, the disclosure relates to a motorcycle backrest.

### BACKGROUND OF THE DISCLOSURE

Long-distance traveling by motorcycle has long been a popular recreational activity in the United States. Motorcycles designed to transport multiple passengers often times do not include proper back support for the driver. Accordingly, long-distance trips by motorcycle can often lead to back pain and fatigue. The present disclosure addresses this problem by providing a motorcycle backrest which may be adapted to fit many motorcycle models in order to provide lower back support for the motorcycle driver or the back seat passenger. Furthermore, the present disclosure can be placed directly between the front and back seat of the motorcycle to accommodate drivers with shorter legs.

### SUMMARY OF THE DISCLOSURE

The present disclosure is directed to a motorcycle backrest. This is accomplished by providing a closed-end, substantially cylindrical geometry filled with a resilient stuffing, having an elongated tongue tangentially extended therefrom, and at least one strap connected on either end of the cylinder running substantially parallel thereto. The present disclosure is held in place by threading the elongated tongue through the existing motorcycle seat strap, or through a retro-fit belt secured around the motorcycle seat between the driver and passenger portion of the motorcycle seat. Next, the tongue is threaded through the strap of the motorcycle backrest. The elongated tongue is of sufficient length so that, when installed, the driver sits on the tongue thereby ensuring the backrest stays in place during the operation of the motorcycle.

When not used as a back support, the motorcycle backrest can be stored on the motorcycle between the handle bars. In this position, the backrest acts as an added safety device by providing padding in the event of a crash. Also, in an alternative embodiment, a pouch is added to the motorcycle backrest for added storage space.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein.

These and other embodiments of the present disclosure will also become readily apparent to those skilled in the art from the following detailed description of the embodiments having reference to the attached figures, the disclosure not being limited to any particular embodiment(s) disclosed.

### BRIEF DESCRIPTION OF THE DRAWINGS

The present disclosure is described with reference to the accompanying drawings. In the drawings, like reference numbers indicate identical or functionally similar elements. Additionally, the left-most digit(s) of a reference number identifies the drawing in which the reference number first appears.

FIG. 1 is a perspective view of a motorcycle backrest.

FIG. 2 is a perspective view of the motorcycle backrest of FIG. 1 showing the initial installation step of placing a belt on the elongated tongue of the backrest.

FIG. 3 is a bottom view of the motorcycle backrest of FIG. 1 showing a subsequent installation step of threading the elongated tongue of the backrest through the integrated strap of the backrest.

FIG. 4 is a bottom view showing the motorcycle backrest of FIG. 1 secured to a belt to be attached to a motorcycle seat.

FIG. 5 is a front perspective view showing the motorcycle backrest of FIG. 1 secured to a belt to be attached to a motorcycle seat.

FIG. 6 is a top view of the motorcycle backrest of FIG. 1 showing the Velcro opening through which the stuffing is inserted and removed.

FIG. 7 is a perspective view of the motorcycle backrest of FIG. 1 installed on a motorcycle.

FIG. 8 is a side view of the motorcycle backrest of FIG. 1 installed on a motorcycle providing back support to a driver.

### DETAILED DESCRIPTION

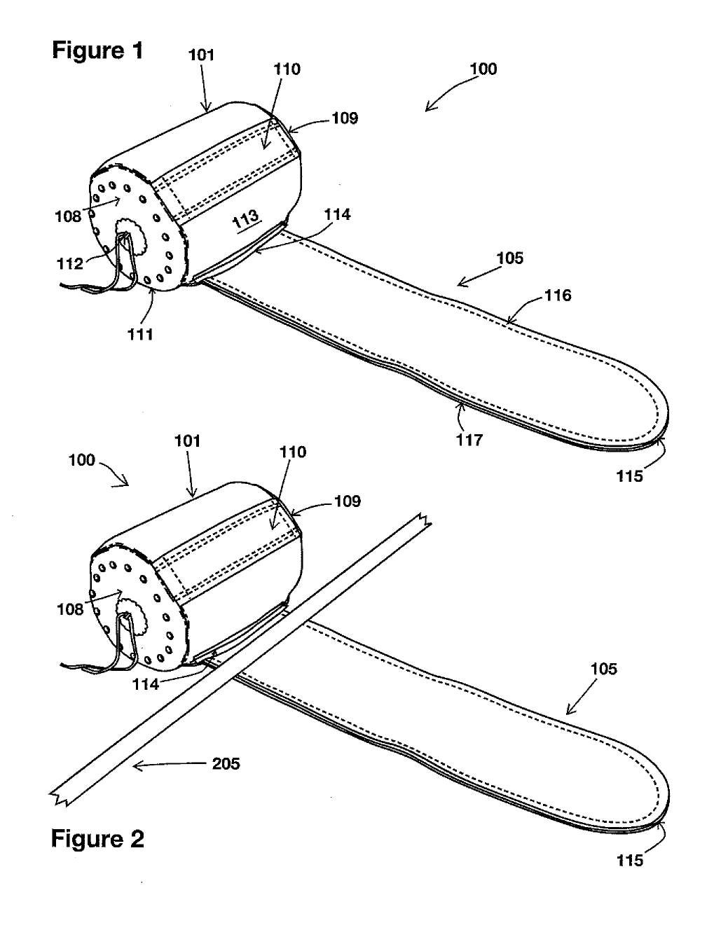

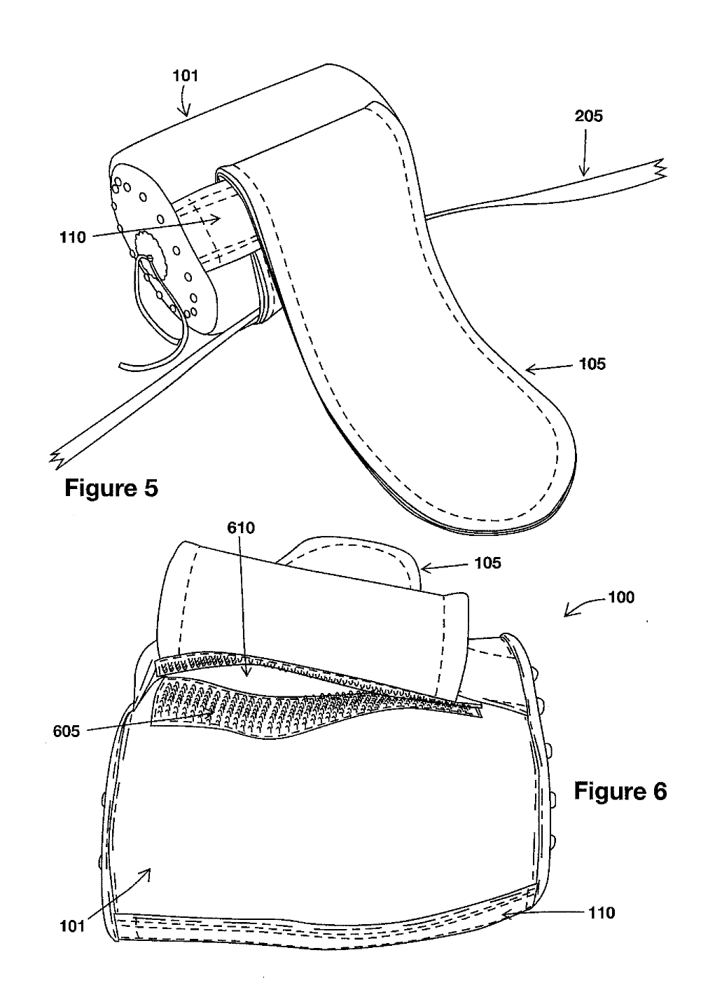

The various embodiments of the present disclosure and their advantages are best understood by referring to FIGS. 1 through 8 of the drawings. The elements of the drawings are not necessarily to scale, emphasis instead being placed upon clearly illustrating the principles of the disclosure. Throughout the drawings, like numerals are used for like and corresponding parts of the various drawings.

Referring now to FIG. 1, in one embodiment the motorcycle backrest 100 of the present disclosure provides a closed-end, substantially cylindrical casing 101 filled with a resilient stuffing (not shown). The casing 101 comprises a substantially cylindrical backrest portion 113 joined to two generally round ends 108 and 109. In one embodiment the width of the casing 101 from end to end is nine inches, and its diameter is seven inches. However, the width of the casing 101 may range from six to fifteen inches; and the diameter may range from five to nine inches.

An elongated tongue 105 extends tangentially from the casing 101 and in one embodiment has a secured end 114 secured to the casing 101, a free end 115, and longitudinal sides 116 and 117. A strap 110 connects at both ends 108, 109 of the casing 101 and runs substantially parallel to the cylindrical backrest portion 113. The strap 110 retains the tongue 105 when the backrest 100 is installed on a motorcycle (not shown). In this regard, the tongue 105 slides underneath the strap 110 and is then held in place between the strap 110 and the backrest portion 113, as further disclosed herein. The width of the strap 110 should be sufficient to withstand the forces placed upon the backrest 100, and in some embodiments is in the range of one-half to six inches wide.

The elongated tongue 105 stabilizes the backrest 100 when in use by providing a surface parallel to the motorcycle seat 701 (FIG. 8) upon which a rider 801 (FIG. 8) sits. In some embodiments, the tongue 105 is substantially rectangular and its length ranges from twelve to thirty-six inches in length in order to provide a sufficient surface upon which the rider 801 (FIG. 8) of the motorcycle 802 (FIG. 8) may sit, effectively trapping the elongated tongue 105 between the rider 801 (FIG. 8) and the motorcycle seat 701 (FIG. 8) in order to maintain the backrest in a supporting position. In some embodiments of the backrest 100, the width of the tongue is generally less than or equal to the width of the motorcycle seat 701.

In alternative embodiments, the casing 101 may form other shapes and sizes. For example, the cross-section of the casing may be elliptical, rectangular, crescent-shaped, semi-circular, or may be grooved to custom fit the motorcycle on which it shall be used.

The secured end 114 of the elongated tongue 105 may either be sewn to the casing 101 or attached to the casing 101 with one or more fasteners such as snaps, buttons, Velcro, a zipper, or the like. To enhance the appearance of the present disclosure, nickel studs 111 or other ornamental features 112 can be added to each end of the casing 101.

In one embodiment, the casing 101, strap 110 and elongated tongue 105 are made of marine vinyl to withstand moisture, hot sun, and exposure to the elements. However, other materials capable of withstanding weather and the elements, such as leather and Gore-tex, may be used. The stuffing (not shown) for the motorcycle backrest may be one-piece foam (not shown) formed to match the shape of the casing 101, but other stuffing known in the art such as polyester fiber, cotton, down, memory foam, and chipped foam may be used. Various densities of the stuffing may be used in order to provide varying levels of support. To prevent water absorption by the stuffing, the stuffing may be covered with plastic (not shown). Such plastic would have the added benefit of allowing the creation of vacuum by compressing the stuffing, thereby making it easier to insert the stuffing into the casing 101.

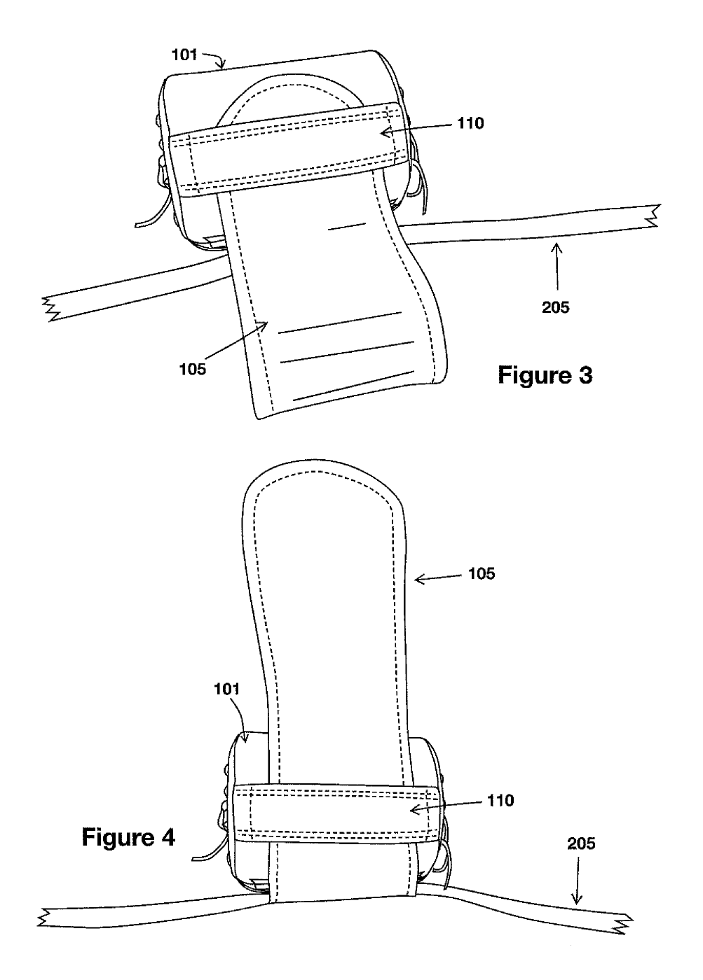

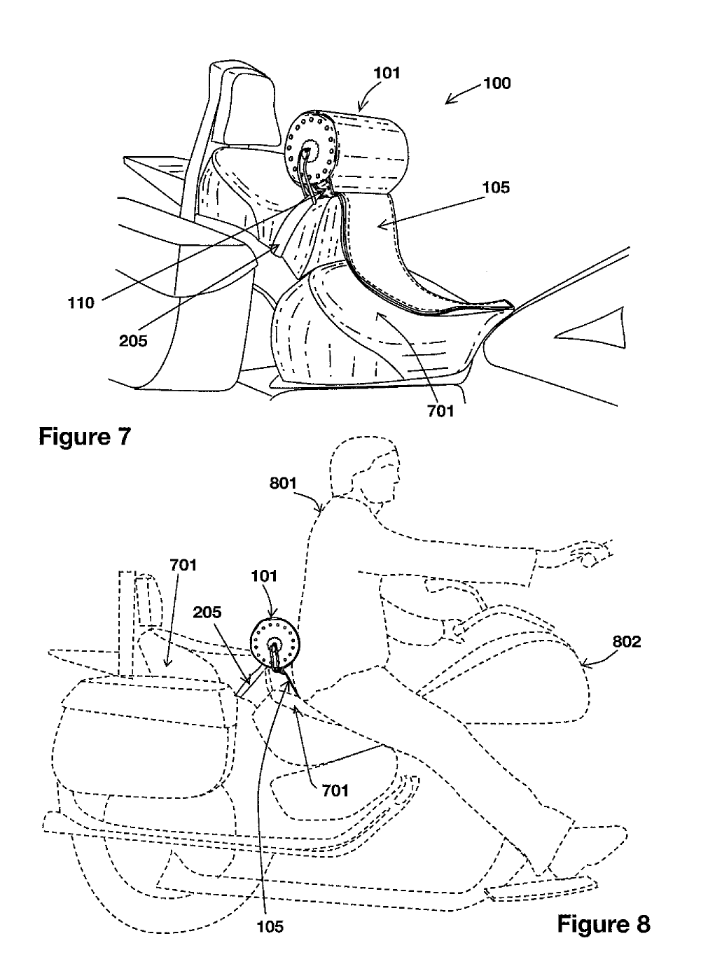

FIGS. 2-5 show the procedure for installing the motorcycle backrest 100 onto a motorcycle (not shown). The motorcycle backrest 100 is retained on the motorcycle (not shown) by threading the free end 115 of the elongated tongue 105 through a belt 205 which is subsequently secured to a motorcycle seat 701 (FIG. 7). As shown in various stages of installation in FIGS. 3, 4, and 5, the free end 115 of the elongated tongue 105 is then threaded through the strap 110 effectively retaining the backrest 100 to the belt 205. The free end 115 of the elongated tongue 105 is then bent down and placed onto the motorcycle seat 701 (FIG. 8) and the rider 801 sits upon the tongue 105 and the seat 701, thus stabilizing the backrest 100.

Some motorcycles may contain a pre-installed motorcycle seat strap (not shown). In this case, the elongated tongue 105 is first threaded through the motorcycle seat strap, then threaded through the strap 110 of the motorcycle backrest 100.

As shown in FIG. 6, one embodiment of the motorcycle backrest 100 includes an opening 610 through which the backrest's stuffing (not shown) is inserted and removed. After inserting the stuffing, the opening can be sealed with the Velcro 605 attached to either side of the opening. In alternative embodiments, the opening 610 may be sealed with fasteners such as buttons and snaps, a zipper, or other attachment means.

As shown in FIGS. 7 and 8, once the motorcycle backrest 100 is installed, the elongated tongue 105 rests upon the motorcycle seat 701. In this way, the rider 801 of the motorcycle 802 (FIG. 8) may sit on the elongated tongue 105, effectively trapping the elongated tongue 105 between the rider 801 and the motorcycle seat 701 in order to maintain the backrest 100 in a supporting position. Depending on the needed support, the position of the motorcycle backrest of the present disclosure may be adjusted by moving the belt 205 along the motorcycle seat 701.

This disclosure may be provided in other specific forms and embodiments without departing from the essential characteristics as described herein. The embodiments described above are to be considered in all aspects as illustrative only and not restrictive in any manner. The appended claims rather than the foregoing description indicate the scope of the disclosure.

As described above and shown in the associated drawings and photographs, the present disclosure comprises a motorcycle backrest. While particular embodiments of the disclosure have been described, it will be understood, however, that the disclosure is not limited thereto, since modifications may be made by those skilled in the art, particularly in light of the foregoing teachings. It is, therefore, contemplated by the appended claims to cover any such modifications that incorporate those features or those improvements that embody the spirit and scope of the present disclosure.

What is claimed is:

1. A motorcycle backrest comprising:
a backrest;
an elongated tongue connected to said backrest; and
at least one strap for securing the backrest to a motorcycle.

2. The motorcycle backrest of claim 1 wherein the tongue stabilizes the backrest on the motorcycle when a motorcycle rider sits upon the tongue.

3. The motorcycle backrest of claim 1 wherein a first end of said strap is fixed to a first end of said backrest, and a second end of said strap is fixed to a second end of said backrest.

4. The motorcycle backrest of claim 1 wherein said backrest is substantially cylindrical.

5. The motorcycle backrest of claim 4 wherein said backrest is from about five to about nine inches in diameter.

6. The motorcycle backrest of claim 1 wherein said backrest is from about six to about fifteen inches wide.

7. The motorcycle backrest of claim 1 wherein said elongated tongue is substantially rectangular.

8. The motorcycle backrest of claim 7 wherein said elongated tongue is from about twelve to thirty-six inches in length.

9. The motorcycle backrest of claim 1 wherein said strap is from about one-half to six inches wide.

10. A motorcycle backrest cover comprising:
a substantially cylindrical casing;
an elongated tongue tangentially connected to said casing; and
at least one strap, wherein a first end of said strap is attached to a first end of said casing, and a second end of said strap is attached to a second end of said casing.

11. The motorcycle backrest of claim 10 wherein said casing is from about five to about nine inches in diameter.

12. The motorcycle backrest of claim 10 wherein said casing is from about six to about fifteen inches wide.

13. The motorcycle backrest of claim 10 wherein said elongated tongue is substantially rectangular.

14. The motorcycle backrest of claim 13 wherein said elongated tongue is from about twelve to thirty-six inches in length.

15. The motorcycle backrest of claim 10 wherein said strap is from about one-half to six inches wide.

16. A method of securing a backrest to a motorcycle seat, comprising the steps of securing a strap transversely across a motorcycle seat;
a. securing an elongated tongue to a backrest;
b. sliding the elongated tongue underneath the strap;
c. placing the tongue onto the motorcycle seat; and
d. sitting on the tongue to stabilize the backrest.
